(19) United States
(12) Patent Application Publication
(10) Pub. No.: US 2025/0271887 A1
(43) Pub. Date: Aug. 28, 2025

(54) LDO REGULATOR, METHOD OF OPERATING THE SAME, AND POWER MANAGEMENT DEVICE INCLUDING THE SAME

(71) Applicant: Foundation of Soongsil University-Industry Cooperation, Seoul (KR)

(72) Inventors: Youngha HWANG, Seoul (KR); Hee-Cheol JOO, Seoul (KR); Yoochang KIM, Seoul (KR); Seung Chae JUNG, Seoul (KR); Seunghoon YI, Seoul (KR)

(73) Assignee: Foundation of Soongsil University-Industry Cooperation, Seoul (KR)

(21) Appl. No.: 19/022,482

(22) Filed: Jan. 15, 2025

(30) Foreign Application Priority Data
Feb. 22, 2024 (KR) 10-2024-0026127

(51) Int. Cl. G05F 1/575; G05F 1/569

(52) U.S. Cl. CPC G05F 1/575; G05F 1/569

(57) ABSTRACT

The present invention relates to an LDO regulator, and more specifically, to an LDO regulator that can quickly respond to voltage droop due to load current fluctuation and operate stably even at a low input voltage, a driving method thereof, and a power management apparatus including the same.

### CROSS-REFERENCE TO RELATED APPLICATIONS

This application claims the benefit of Korean Application No. 10-2024-0026127, filed Feb. 22, 2024, in the Korean Intellectual Property Office. All disclosures of the document named above are incorporated herein by reference.

### TECHNICAL FIELD

The present invention relates to an LDO regulator, and more specifically, to an LDO regulator capable of quickly responding to a voltage droop due to a load current fluctuation and operating stably even at a low input voltage, a method for driving the same, and a power management apparatus including the same.

### BACKGROUND ART

Recently, smart electronic devices support the function of detecting a specific word (keyword spotting) when the user utters a specific word in the idle state, switching to the active state, and performing a specific action. For example, the smart electronic device detects a designated wake-up signal and provides the user with specific information through the device's display screen, or executes the AI personal assistant software installed in the smart electronic device.

These functions are evolving to be supported by edge devices on the user side, but edge devices on the user side are mainly devices that are powered by batteries. The part that detects the wake-up signal to switch from the idle state to the active state, such as word detection, should always be on, and at the same time, power management technology that minimizes power consumption and controls it to maximize battery usage time is very important.

For this power control, various main power functions are included on the System-on-Chip (SoC), and each main power function receives a stable power voltage through an LDO (Low-DropOut) regulator, which is a voltage regulator.

However, the current LDO regulator has a problem in that it is difficult to predict the load current fluctuation according to the wake-up signal in advance, making it difficult to respond quickly to a possible voltage droop. In addition, for the stable operation of the current LDO regulator, a minimum input voltage of 0.6 V or higher is required, and there is a problem in that stable operation is difficult at a low input voltage such as 0.4 V.

### RELATED ART

Korean Patent No. 10-2591043, registered on Oct. 13, 2023 (Title: LDO voltage regulator with improved voltage regulation rate, driving method thereof, and electronic device including the same)

### DISCLOSURE

### Technical Issues

The technical problem of the present invention is proposed to solve such problems, and the purpose is to provide an LDO regulator that can quickly respond to voltage droop due to load current fluctuation and can operate stably even at low input voltage, a driving method thereof, and a power management apparatus including the same.

However, the purpose of the present invention is not limited to the above purpose, and other purposes that are not mentioned can be clearly understood from the description below.

### Technical Solution

In order to achieve the above object, according to one embodiment of the present invention, an LDO regulator comprises an error amplifier that generates a control voltage by considering an error between a reference voltage and an output voltage generated from a pass transistor, and then transmits the generated control voltage to the pass transistor and performs an operation in response to a bias voltage; a load adaptive bias generator connected to an output terminal of the error amplifier that receives the control voltage transmitted from the error amplifier to the pass transistor, generates a corresponding bias voltage, and transmits the generated bias voltage to the error amplifier; and a voltage droop predictor whose output node is connected to a point where the output voltage generated from the pass transistor is transmitted to a load, and that, when at least one of a voltage droop signal in which the output voltage droops below a certain range or a wake-up signal transmitted from outside is detected, transmits an input voltage to the load connected to the output node.

The error amplifier may comprise a core OTA that performs an on/off operation in response to the bias voltage transmitted from the load adaptive bias generator.

The LDO regulator further comprises a class AB including a first transistor connected to the output terminal of the error amplifier and turned on when the control voltage is transmitted through the output terminal, and pulling up and transmitting the control voltage, and a second transistor connected to the output terminal of the error amplifier and turned on when the control voltage is transmitted through the output terminal, and pulling down and transmitting the control voltage, wherein class AB is connected to the load adaptive bias generator and transmits the pulled-up or pulled-down control voltage to the load adaptive bias generator.

The load adaptive bias generator comprises a replica pass transistor of the pass transistor connected to a point where the control voltage is transmitted from the error amplifier to the pass transistor that receives the control voltage; a third transistor connected in parallel to the replica pass transistor; and a fourth transistor connected to the error amplifier and connected in parallel to the third transistor, wherein the third transistor and the fourth transistor generate a bias voltage according to a drain current corresponding to the control voltage, wherein the fourth transistor transmits the generated bias voltage to the error amplifier.

The voltage droop predictor comprises a fifth transistor connected to an input voltage; and a droop detector whose output node is connected to a point where an output voltage generated from the pass transistor is transmitted to a load, and that, when at least one of a voltage droop signal in which the output voltage droops below a certain range and a wake-up signal transmitted from outside is detected, that turns on the fifth transistor so that the input voltage is transmitted to the load connected to the output node.

When the fifth transistor is connected to a ground voltage, the input voltage may be the ground voltage.

In order to achieve the above object, according to one embodiment of the present invention, a method for driving an LDO regulator comprises pulling up, when the load current changes from a large value to a small value, a control voltage outputted through an error amplifier and transmitting it to a pass transistor, and transmitting a bias voltage lowered in response to the load current to the error amplifier to reduce standby current consumption in the error amplifier; pulling down, when the load current changes from a small value to a large value, a control voltage outputted through an error amplifier and transmitting it to a pass transistor, and transmitting a bias voltage increased in response to the load current to the error amplifier to increase operating speed of the error amplifier; transmitting, when at least one of a voltage droop signal in which an output voltage generated from the pass transistor droops below a certain range or a wake-up signal transmitted from outside is detected, an input voltage to a load to prevent voltage droop.

In order to achieve the above object, according to one embodiment of the present invention, a power management apparatus in a device that switches from an idle state to an active state according to a predefined wake-up signal comprises a front-end that, when a wake-up signal is detected, transmits the detected wake-up signal to a back-end; a back-end that switches to an active state according to a wake-up signal transmitted from the front-end during an idle state; and an LDO regulator that transmits an input voltage to the back-end to prevent voltage droop when the wake-up signal transmitted from the front-end to the back-end is detected.

The LDO regulator comprises an error amplifier that generates a control voltage by considering an error between a reference voltage and an output voltage generated from a pass transistor, and then transmits the generated control voltage to the pass transistor and performs an operation in response to a bias voltage; a load adaptive bias generator connected to an output terminal of the error amplifier, and that receives the control voltage transmitted from the error amplifier to the pass transistor, generates a corresponding bias voltage, and transmits the generated bias voltage to the error amplifier; and a voltage droop predictor whose output node is connected to a point where the output voltage generated from the pass transistor is transmitted to a load, and that, when at least one of a voltage droop signal in which the output voltage droops below a certain range or a wake-up signal transmitted from outside is detected, transmits an input voltage to the load connected to the output node.

The error amplifier comprises a core OTA that performs an on/off operation in response to the bias voltage transmitted from the load adaptive bias generator.

The load adaptive bias generator comprises a replica pass transistor of the pass transistor connected to a point where the control voltage is transmitted from the error amplifier to the pass transistor, and that receives the control voltage; a third transistor connected in parallel to the replica pass transistor; and a fourth transistor connected to the error amplifier and connected in parallel to the third transistor, wherein the third transistor and the fourth transistor generate a bias voltage according to a drain current corresponding to the control voltage, wherein the fourth transistor transmits the generated bias voltage to the error amplifier.

The voltage droop predictor comprises a fifth transistor connected to an input voltage; and a droop detector whose output node is connected to a point where an output voltage generated from the pass transistor is transmitted to a load, and that, when at least one of a voltage droop signal in which the output voltage droops below a certain range and the wake-up signal is detected, turns on the fifth transistor so that the input voltage is transmitted to the load connected to the output node.

### Advantageous Effects

According to the LDO regulator of the present invention, the driving method thereof, and the power management apparatus including the same, it is possible to prevent a sudden voltage droop in advance by quickly responding to a load current fluctuation that may occur when switching from an idle state to an active state according to a wake-up signal.

In addition, according to the present invention, it is possible to operate stably without an additional external capacitor even at a low input voltage such as 0.4 V, and it is possible to reduce the standby current consumption of the LDO regulator itself.

In addition, various effects other than the above-described effects may be directly or implicitly disclosed in the detailed description according to the embodiment of the present invention to be described later.

### DESCRIPTION OF DRAWINGS

These and/or other aspects will become apparent and more readily appreciated from the following description of the embodiments, taken in conjunction with the accompanying drawings in which:

FIG. 1 is an exemplary diagram schematically illustrating a power management apparatus including an LDO regulator according to an embodiment of the present invention;

FIG. 2 is a circuit diagram illustrating a circuit for an LDO regulator according to an embodiment of the present invention;

FIG. 3 and FIG. 4 are circuit diagrams illustrating a driving method of an LDO regulator according to an embodiment of the present invention; and

FIG. 5 to FIG. 7 are graphs illustrating effects that can be exerted through an LDO regulator according to an embodiment of the present invention.

### DETAILED DESCRIPTION OF EMBODIMENTS

In order to more clearly explain the features and advantages of the problem-solving means of the present invention, the present invention will be described in more detail with reference to specific embodiments of the present invention illustrated in the attached drawings.

However, detailed descriptions of well-known functions or configurations that may obscure the gist of the present invention in the following description and the attached drawings will be omitted. In addition, it should be noted that the same components are indicated by the same drawing reference numerals as much as possible throughout the drawings.

The terms or words used in the following description and drawings should not be interpreted as limited to their conventional or dictionary meanings, and should be interpreted as meanings and concepts that conform to the technical idea of the present invention based on the principle that the inventor can appropriately define the concept of the term to explain his own invention in the best way. Therefore, the embodiments described in this specification and the configurations illustrated in the drawings are only the most preferred embodiments of the present invention, and do not represent all of the technical idea of the present invention, so it should be understood that there may be various equivalents and modified examples that can replace them at the time of filing this application.

In addition, terms including ordinal numbers such as first, second, etc. are used to describe various components, and are only used for the purpose of distinguishing one component from another, and are not used to limit the components. For example, without departing from the scope of the present invention, the second component may be named the first component, and similarly, the first component may also be named the second component.

In addition, when it is mentioned that a component is “connected” or “contacted” to another component, it means that it can be connected or contacted logically or physically. In other words, it should be understood that a component may be directly connected or contacted to another component, but there may also be other components in between, and it may be indirectly connected or contacted.

In addition, the terms used in this specification are only used to describe specific embodiments, and are not intended to limit the present invention. The singular expression includes the plural expression unless the context clearly indicates otherwise. In addition, it should be understood that the terms “include” or “have” described in this specification are intended to specify the presence of a feature, number, step, operation, component, part, or combination thereof described in the specification, and do not preemptively exclude the possibility of the presence or addition of one or more other features, numbers, steps, operations, components, parts, or combinations thereof.

Hereinafter, an LDO regulator, a driving method thereof, and a power management apparatus including the same according to an embodiment of the present invention will be described.

First, a power management apparatus including an LDO regulator according to an embodiment of the present invention will be described.

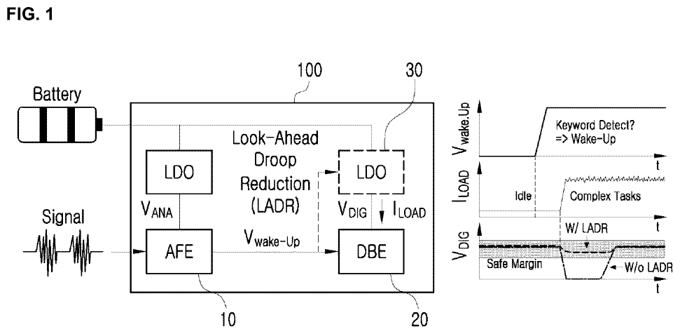

FIG. 1 is an exemplary diagram for schematically explaining a power management apparatus including an LDO regulator according to an embodiment of the present invention.

Referring to FIG. 1, the power management apparatus 100 of the present invention is an apparatus that can be implemented in the form of a computing system such as a System on Chip (SoC) or an integrated circuit that integrates components of other electronic systems, and may be a camera driving circuit (OIS driver IC), a wireless power transmission circuit (WPT IC), a high-frequency circuit (RF IC), a keyword spotting circuit (Keyword Spotting IC), etc.

Hereinafter, the power management apparatus 100 according to an embodiment of the present invention is described as a keyword spotting IC that can be switched to an active state by detecting a specific keyword such as a wake-up word, but is not necessarily limited thereto, and the power management apparatus of the present invention can be applied to any device that can be switched from an idle state to an active state according to a designated wake-up signal in addition to keyword detection. In addition, the power management apparatus 100 described above may be configured to include more diverse components in addition to the front-end 10, back-end 20, and LDC regulator 30 described below.

The power management apparatus 100 according to an embodiment of the present invention comprises a front-end (AFE) 10 that processes an analog signal and a back-end (DBE) 20 that processes a digital signal. When a wake-up signal such as keyword utterance is detected in the front-end 10 through a sensor, the back-end 20, which was in an idle state, switches to an active state to analyze the wake-up signal and performs complex operations such as voice recognition and recording.

In the back-end 20 switched to an active state, various modules perform operations, causing a sharp increase in current consumption, and if the LDO regulator 30 that supplies power voltage to the back-end 20 does not respond quickly, a voltage droop occurs in which the supply voltage droops significantly momentarily, making normal operation of the back-end 20 difficult, and there is a possibility that data in the memory on the back-end 20 side may be partially lost.

Therefore, in order to solve this problem, the LDO regulator 30 connected to the back-end 20 of the power management apparatus 100 according to an embodiment of the present invention comprises a Look-Ahead Droop Reduction (LADR) function to quickly respond to voltage droop due to load current fluctuations.

The LADR function defined in the present invention means a function in which the LDO regulator 30 detects a wake-up signal (V_{WAKE-UP}) transmitted from the front end 10 to the back end 20, and thereby secures the output voltage above a certain voltage in advance and transmits it to the back end 20 in order to prevent a voltage droop that may occur.

The LDO regulator including the LADR function according to the embodiment of the present invention can quickly respond to a sudden load current change by pre-regulating the output voltage above a certain voltage in order to prevent a voltage droop.

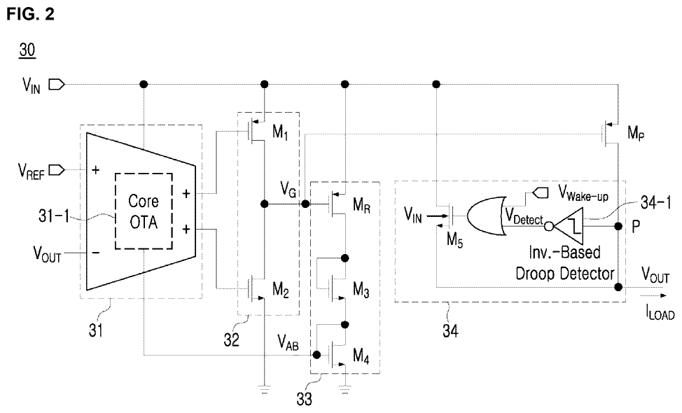

The main configuration and operation of the LDO regulator will be described in more detail with reference to FIG. 2.

FIG. 2 is a circuit diagram illustrating a circuit for an LDO regulator according to an embodiment of the present invention.

Referring to FIG. 2, the LDO regulator 30 according to the embodiment of the present invention may be configured to comprise an error amplifier (Adaptive-Biased EA, 31), a class AB 32, a load-adaptive bias generator 33 and a voltage droop predictor (Look-Ahead Droop Reduction, LADR) 34.

To describe each component in more detail, first, the error amplifier 31 is an analog amplifier that receives two analog voltage signals as inputs, amplifies the difference between them, and outputs a control voltage (V_{G}). A reference voltage (V_{REF}) is input to the plus (+) input terminal, and an output voltage (V_{OUT}), which is a feedback voltage, is input to the minus (−) input terminal. The error between the two voltages is detected so that the output voltage (V_{OUT}) can have the same value as the reference voltage (V_{REF}), and the control voltage (V_{G}), which is a gate node voltage of the pass transistor (M_{P}), is output in the direction of reducing the error.

At this time, the output terminal of the error amplifier 31 of the present invention comprises an upper output terminal and a lower output terminal, and transmits a control voltage (V_{G}) to the output terminal by considering the error between the two voltages.

For example, when the load current (I_{LOAD}) is small, the output voltage (V_{OUT}) is maintained similar to the reference voltage (V_{REF}), so that the output voltage (V_{OUT}) is high, and the output of the error amplifier 31 is reduced, so that the control voltage (V_{G}) is transmitted to the upper plus (+) output terminal, and the first transistor (M1) of the class AB 32 connected to the upper plus (+) output terminal of the error amplifier 31 is turned on to pull up the control voltage (V_{G}), and then the pulled-up control voltage (V_{G}) can be transmitted more quickly to the pass transistor (M_{P}).

On the other hand, when the load current (I_{LOAD}) increases, the difference between the output voltage (V_{OUT}) and the reference voltage (V_{REF}) increases, so that the output voltage (V_{OUT}) is low, and the error amplifier 31 of the present invention increases the output so that the output voltage (V_{OUT}) can have the same value as the reference voltage (V_{REF}) and transmits the control voltage (V_{G}) to the lower plus (+) output terminal, and the second transistor (M2) of the class AB 32 connected to the lower plus (+) output terminal of the error amplifier 31 is turned on to pull down the control voltage (V_{G}), and then the pulled-down control voltage (V_{G}) can be transmitted more quickly to the pass transistor (M_{P}).

In addition, the error amplifier 31 according to the embodiment of the present invention can be implemented in the form of an operational transconductance amplifier (OTA), and can control the operation of the core OTA 31-1 that performs the function of outputting the input voltage as an output current in proportion to the transconductance (Gm) in response to the bias voltage (V_{AB}) transmitted through the load adaptive bias generator 33.

That is, when the load current (I_{LOAD}) is small, the bias voltage (V_{AB}) is also small, so that less current is consumed, and when the load current (I_{LOAD}) increases, the bias voltage (V_{AB}) increases, so that the error amplifier 31 should operate faster. Therefore, in order to consume more current only when it is necessary to operate quickly and reduce current consumption in other cases, the error amplifier 31 of the present invention controls the operation of the core OTA 31-1 in response to the bias voltage (V_{AB}). When the bias voltage (V_{AB}) transmitted through the load adaptive bias generator 33 is lowered below a certain value, the operation of the core OTA 31-1 is turned off to reduce standby current (quiescent current) consumption, and when the bias voltage (V_{AB}) transmitted through the load adaptive bias generator 33 is above a certain value, the operation of the core OTA 31-1 is turned on, enabling operation to be performed more quickly.

As described above, the class AB 32 is configured to comprise the first transistor (M1) and the second transistor (M2) connected to the output terminal of the error amplifier 31, and the control voltage (V_{G}) is complementarily pulled up or pulled down to transmit the control voltage (V_{G}) more quickly to the connected load adaptive bias generator 33.

That is, the first transistor (M1) has its gate connected to the upper output terminal of the error amplifier 31, pulls up the control voltage (V_{G}) transmitted from the error amplifier 31, and then outputs the pulled-up control voltage (V_{G}) through the drain, so that it can be transmitted toward the pass transistor (M_{P}) and the load adaptive bias generator 33 connected to each point.

The second transistor (M2) has its gate connected to the lower output terminal of the error amplifier 31, and may pull down the control voltage (V_{G}) transmitted from the error amplifier 31, and then transmit the pulled-down control voltage (V_{G}) toward the pass transistor (M_{P}) through the source.

The load adaptive bias generator 33 comprises a replica pass transistor (M_{R}), which is a replica transistor of the pass transistor (M_{P}), and the replica pass transistor (M_{R}) is also a PMOS transistor, just like the pass transistor (M_{P}), and its physical quantity may also be the same as that of the pass transistor (M_{P}).

The replica pass transistor (M_{R}) receives the control voltage (V_{G}) output from the error amplifier 31 through the first transistor (M1) or the second transistor (M2) through the gate, receives the input voltage (V_{IN}) through the source, and is connected to the third transistor (M3) through the drain. The replica pass transistor (M_{R}) can perform an on/off operation in response to the control voltage (V_{G}). Depending on the on/off operation of the replica pass transistor (M_{R}), the third transistor (M3) and the fourth transistor (M4) connected in parallel to the replica pass transistor (M_{R}) generate a corresponding bias voltage (V_{AB}), and the generated bias voltage (V_{AB}) can be transmitted back to the error amplifier 31.

More specifically, when the load current (I_{LOAD}) increases, the difference between the output voltage (V_{OUT}) and the reference voltage (V_{REF}) increases, so that the output voltage (V_{OUT}) becomes smaller than the reference voltage (V_{REF}), and the control voltage (V_{G}) is pulled down and lowered. The replica pass transistor (M_{R}), which receives the pulled-down control voltage (V_{G}) through its gate node, is turned on and operates as a current source, and receives this current and transmits it toward the third transistor (M3) and the fourth transistor (M4), and the bias voltage (V_{AB}), which is the voltage created through the third transistor (M3) and the fourth transistor (M4), increases.

On the other hand, when the load current (I_{LOAD}) is small, the output voltage (V_{OUT}) is maintained similar to the reference voltage (V_{REF}), so that the output voltage (V_{OUT}) is high, and the control voltage (V_{G}) is pulled up and increases. Since the control voltage (V_{G}) is pulled up, the replica pass transistor (M_{R}) is turned off, and the bias voltage (V_{AB}), which is a voltage generated through the third transistor (M3) and the fourth transistor (M4), also decreases because the replica pass transistor (M_{R}), which operates as a current source, is turned off.

The bias voltage (V_{AB}) generated through this process is transmitted to the error amplifier 31 by the fourth transistor (M4) connected to the error amplifier 31. When a high bias voltage (V_{AB}) is transmitted to the error amplifier 31, the core OTA 31-1 of the error amplifier 31 is turned on, so that the operation of the error amplifier 31 can be made faster. When a low bias voltage (V_{AB}) is transmitted to the error amplifier 31, the core OTA 31-1 of the error amplifier 31 is turned off, so that the standby current consumption of the error amplifier 31 can be reduced.

Meanwhile, the pass transistor (M_{P}) of the present invention may comprise a PMOS transistor and function as a voltage-controlled current switch. That is, the pass transistor (M_{P}) receives an input voltage (V_{IN}) through a source, receives a control voltage (V_{G}) through a gate, and the drain is connected to an output node (P), so that the output voltage (V_{OUT}) is transmitted to a load (not shown). When the current of the load, i.e., the load current (I_{LOAD}), changes, the output voltage (V_{OUT}) changes, and the control voltage (V_{G}) output through the error amplifier 31 is adjusted, so that the output voltage (V_{OUT}) of the pass transistor (M_{P}) can be controlled within a certain range. However, in a state of small load current (I_{LOAD}), when the load current (I_{LOAD}) increases rapidly, the response speed (transient response) of the pass transistor (M_{P}) may be slow.

This problem can become more severe as the input voltage (V_{IN}) is lower, for example, in an environment of 0.4 V or lower. To solve this problem, the LDO regulator 30 of the present invention comprises a voltage droop predictor 34. When the voltage droop predictor 34 detects a voltage droop signal in which the output voltage (V_{OUT}) droops below a certain range due to the slow response speed of the pass transistor (M_{P}), the fifth transistor connected to the input voltage (V_{IN}) is turned on to transmit the input voltage (V_{IN}) to the output node (P) in order to compensate for the voltage droop of the output voltage (V_{OUT}).

The voltage droop predictor 34 of the present invention for this purpose comprises an inverter-based droop detector 34-1 to operate well even in an environment where the input voltage (V_{IN}) is low, and when the output voltage (V_{OUT}) droops below a certain range due to a sudden increase in the load current (I_{LOAD}), the output of the inverter is inverted to turn on the fifth transistor (M5), which is an NMOS transistor, and the fifth transistor (M5) connected to the input voltage (V_{IN}) opens another current supply path other than the pass transistor (M_{P}), so that the input voltage (V_{IN}) can be additionally transmitted to a load (not shown).

In addition, the input voltage (V_{IN}) of the present invention may be a power voltage as shown in the drawing, but when the fifth transistor (M5) is connected to a ground voltage (ground), the ground voltage may be transmitted to the load (not shown).

This fifth transistor (M5) can operate in a forward body biasing (FBB) manner in which the input voltage (V_{IN}) is applied to the body terminal so that it can operate well even at a low input voltage (V_{IN}).

In addition, the droop detector 34-1 according to the embodiment of the present invention can detect a voltage droop signal (V_{Detect}) in which the output voltage (V_{OUT}) droops below a certain range and perform the above-described operation, and as described through FIG. 1, it is also possible to detect a wake-up signal (V_{Wake-up}) transmitted from the outside and perform the above-described operation. That is, since a voltage droop in which the output voltage (V_{OUT}) droops below a certain range can occur first, or a wake-up signal that has no voltage droop but has the possibility of a voltage droop can be detected first, if the wake-up signal is detected first, the output voltage (V_{OUT}) can be controlled to be maintained within a certain range before the voltage droop occurs.

The main configuration of the LDO regulator 30 according to the embodiment of the present invention has been described above.

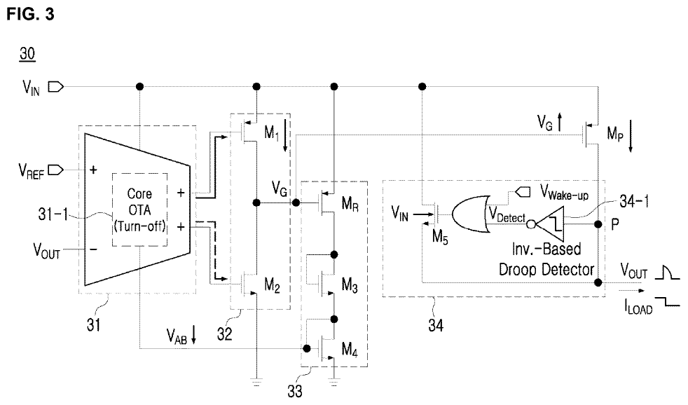

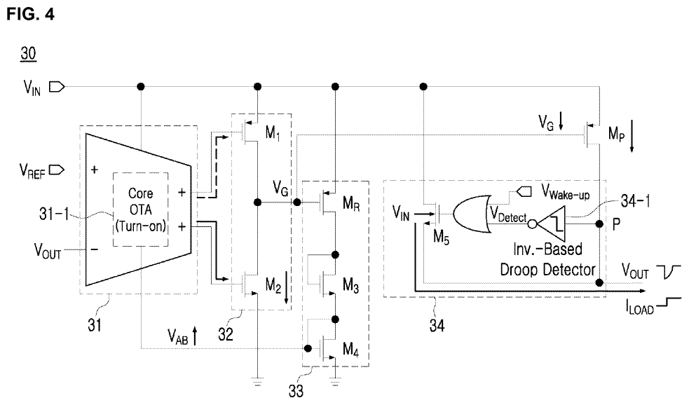

Hereinafter, a driving method of the LDO regulator according to the embodiment of the present invention will be described with reference to FIGS. 3 and 4.

FIGS. 3 and 4 are circuit diagrams for explaining a driving method of the LDO regulator according to the embodiment of the present invention. First, FIG. 3 illustrates a case where the load current (I_{LOAD}) changes from a large value to a small value, for example, a case where a device including the LDO regulator enters an idle state.

When the load current (I_{LOAD}) changes to a small value, the output voltage (V_{OUT}) is maintained similar to the reference voltage (V_{REF}), so the output voltage (V_{OUT}) is high, and therefore the control voltage (V_{G}) is pulled up and becomes high. Since the control voltage (V_{G}) is pulled up, the replica pass transistor (M_{R}) is turned off, and the bias voltage (V_{AB}), which is a voltage generated through the third transistor (M3) and the fourth transistor (M4), is lowered because the replica pass transistor (M_{R}) operating as a current source is turned off. The lowered bias voltage (V_{AB}) is transmitted to the error amplifier 31, and the core OTA 31-1 of the error amplifier 31 is turned off, so that the standby current consumption in the error amplifier 31 can be reduced.

On the other hand, FIG. 4 illustrates a case where the load current (I_{LOAD}) changes from a small value to a large value, for example, a case where a device in an idle state enters an activated state according to a wake-up signal and the current consumption increases rapidly.

At this time, when the load current (I_{LOAD}) changes to a large value, the difference between the output voltage (V_{OUT}) and the reference voltage (V_{REF}) increases, so that the output voltage (V_{OUT}) becomes smaller than the reference voltage (V_{REF}), and the control voltage (V_{G}) is pulled down and lowered. The replica pass transistor (M_{R}), which receives the pulled-down control voltage (V_{G}) through the gate node, is turned on and operates as a current source, receives this current and transmits it toward the third transistor (M3) and the fourth transistor (M4), which are NMOS transistors, and the bias voltage (V_{AB}), which is the voltage generated through the third transistor (M3) and the fourth transistor (M4), increases. The increased bias voltage (V_{AB}) is transmitted to the error amplifier 31, and the core OTA 31-1 of the error amplifier 31 is turned on to increase the operating speed of the error amplifier 31, so that it can respond more quickly to a voltage droop that may occur later.

In addition, the pass transistor (M_{P}) of the LDO regulator 30 of the present invention generates an output voltage (V_{OUT}) according to a change in the load current (I_{LOAD}). At this time, when a voltage droop signal (V_{Detect}) is detected in which the output voltage (V_{OUT}) generated from the pass transistor (M_{P}) falls below a certain range, or a wake-up signal (V_{Wake-up}) transmitted from the outside is detected, the fifth transistor (M5) is turned on to create a path so that the input voltage (V_{IN}) can be additionally transmitted to the load, thereby preventing a voltage droop.

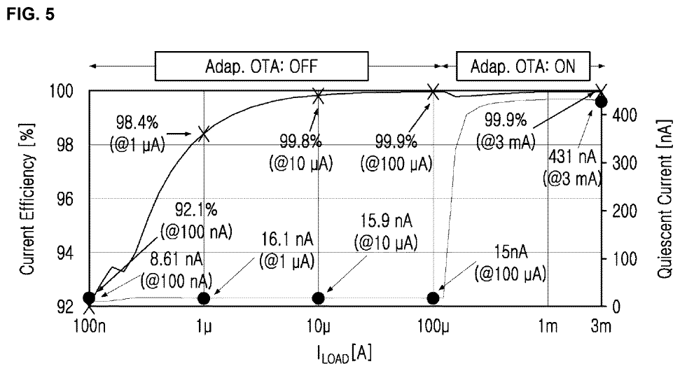

The effects of the present invention will be explained with reference to FIGS. 5 to 7. FIGS. 5 to 7 are graphs for explaining the effects that can be exerted through the LDO regulator according to the embodiment of the present invention. First, FIG. 5 illustrates the current efficiency of the LDO regulator according to the load current and the standby current (quiescent current) of the LDO regulator itself. By applying the LDO regulator of the present invention, the current efficiency can be maintained at 98.5% or higher up to 1 uA, and shows a current efficiency of 92.1% at 100 nA.

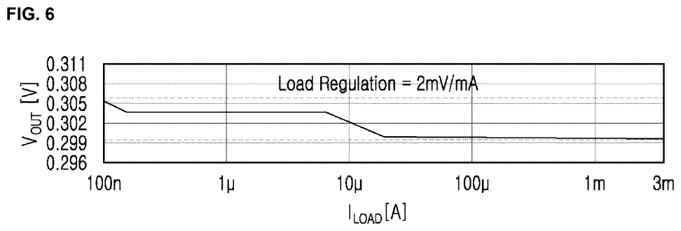

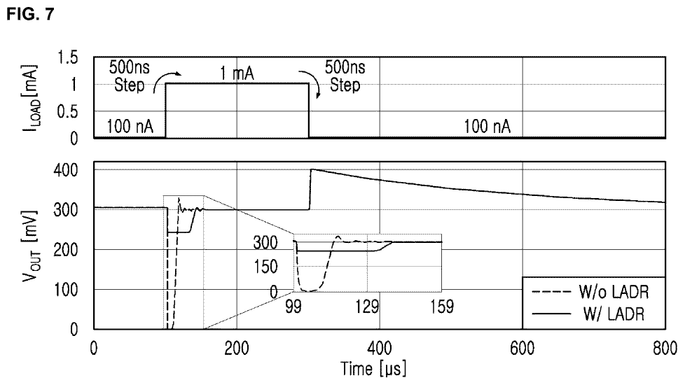

In addition, as shown in FIG. 6, the output voltage of the LDO regulator can secure a precise load regulation performance of 2 mV/mA, and as shown in FIG. 7, by including the LADR function that responds to a large current load in advance, it can be seen that the output of the LDO regulator of the present invention is stably maintained within a certain range and then recovered compared to a general LDO regulator.

The LDO regulator, the driving method thereof, and the power management apparatus including the same according to the embodiment of the present invention have been described above.

Although the present invention has been described with reference to the embodiment illustrated in the drawings, this is merely exemplary, and those skilled in the art will understand that various modifications and equivalent other embodiments are possible from this. Therefore, the technical protection scope of the present invention should be determined by the technical idea of the patent claims.

### INDUSTRIAL APPLICABILITY

The present invention relates to an LDO regulator, and more specifically, to an LDO regulator that can quickly respond to voltage droop due to load current fluctuation and can operate stably even at a low input voltage, a driving method thereof, and a power management apparatus including the same.

According to the present invention, power management can be performed more efficiently in a user-side terminal device because it can quickly respond to voltage droop due to load current fluctuation and can operate stably even at a low input voltage, thereby contributing to the activation of the device industry, and thus has sufficient industrial applicability.

### REFERENCE NUMERALS

10: front end
20: back end
30: LDO regulator
31: error amplifier
32: class AB
33: load adaptive bias generator
34: voltage droop predictor
100: power management apparatus

1. An LDO regulator comprising:
an error amplifier that generates a control voltage by considering an error between a reference voltage and an output voltage generated from a pass transistor, and then transmits the generated control voltage to the pass transistor and performs an operation in response to a bias voltage;
a load adaptive bias generator connected to an output terminal of the error amplifier that receives the control voltage transmitted from the error amplifier to the pass transistor, generates a corresponding bias voltage, and transmits the generated bias voltage to the error amplifier; and
a voltage droop predictor whose output node is connected to a point where the output voltage generated from the pass transistor is transmitted to a load, and that, when at least one of a voltage droop signal in which the output voltage droops below a certain range or a wake-up signal transmitted from outside is detected, transmits an input voltage to the load connected to the output node.

2. The LDO regulator of claim 1, wherein the error amplifier comprises,
a core OTA that performs an on/off operation in response to the bias voltage transmitted from the load adaptive bias generator.

3. The LDO regulator of claim 1 further comprises,
a class AB including a first transistor connected to the output terminal of the error amplifier and turned on when the control voltage is transmitted through the output terminal, and pulling up and transmitting the control voltage, and a second transistor connected to the output terminal of the error amplifier and turned on when the control voltage is transmitted through the output terminal, and pulling down and transmitting the control voltage;
wherein class AB is connected to the load adaptive bias generator and transmits the pulled-up or pulled-down control voltage to the load adaptive bias generator.

4. The LDO regulator of claim 1, wherein the load adaptive bias generator comprises,
a replica pass transistor of the pass transistor connected to a point where the control voltage is transmitted from the error amplifier to the pass transistor and that receives the control voltage;
a third transistor connected in parallel to the replica pass transistor; and
a fourth transistor connected to the error amplifier and connected in parallel to the third transistor,
wherein the third transistor and the fourth transistor generate a bias voltage according to a drain current corresponding to the control voltage,
wherein the fourth transistor transmits the generated bias voltage to the error amplifier.

5. The LDO regulator of claim 1, wherein the voltage droop predictor comprises,
a fifth transistor connected to an input voltage; and
a droop detector whose output node is connected to a point where an output voltage generated from the pass transistor is transmitted to a load, and that, when at least one of a voltage droop signal in which the output voltage droops below a certain range and a wake-up signal transmitted from outside is detected, that turns on the fifth transistor so that the input voltage is transmitted to the load connected to the output node.

6. The LDO regulator of claim 5, wherein, when the fifth transistor is connected to a ground voltage, the input voltage is the ground voltage.

7. A method for driving an LDO regulator comprising:
pulling up, when a load current changes from a large value to a small value, a control voltage outputted through an error amplifier and transmitting it to a pass transistor, and transmitting a bias voltage lowered in response to the load current to the error amplifier to reduce standby current consumption in the error amplifier;
pulling down, when the load current changes from a small value to a large value, a control voltage outputted through an error amplifier and transmitting it to a pass transistor, and transmitting a bias voltage increased in response to the load current to the error amplifier to increase operating speed of the error amplifier;
transmitting, when at least one of a voltage droop signal in which an output voltage generated from the pass transistor droops below a certain range or a wake-up signal transmitted from outside is detected, an input voltage to a load to prevent voltage droop.

8. A power management apparatus in a device that switches from an idle state to an active state according to a predefined wake-up signal comprising:
a front-end that, when a wake-up signal is detected, transmits the detected wake-up signal to a back-end;
a back-end that switches to an active state according to a wake-up signal transmitted from the front-end during an idle state; and
an LDO regulator that transmits an input voltage to the back-end to prevent voltage droop when the wake-up signal transmitted from the front-end to the back-end is detected.

9. The apparatus of claim 8, wherein the LDO regulator comprises,
an error amplifier that generates a control voltage by considering an error between a reference voltage and an output voltage generated from a pass transistor, and then transmits the generated control voltage to the pass transistor and performs an operation in response to a bias voltage;
a load adaptive bias generator connected to an output terminal of the error amplifier, and that receives the control voltage transmitted from the error amplifier to the pass transistor, generates a corresponding bias voltage, and transmits the generated bias voltage to the error amplifier; and
a voltage droop predictor whose output node is connected to a point where the output voltage generated from the pass transistor is transmitted to a load, and that, when at least one of a voltage droop signal in which the output voltage droops below a certain range or a wake-up signal transmitted from outside is detected, transmits an input voltage to the load connected to the output node.

10. The apparatus of claim 9, wherein the error amplifier comprises,
a core OTA that performs an on/off operation in response to the bias voltage transmitted from the load adaptive bias generator.

11. The apparatus of claim 9, wherein the load adaptive bias generator comprises,
a replica pass transistor of the pass transistor connected to a point where the control voltage is transmitted from the error amplifier to the pass transistor, and that receives the control voltage;
a third transistor connected in parallel to the replica pass transistor; and
a fourth transistor connected to the error amplifier and connected in parallel to the third transistor,
wherein the third transistor and the fourth transistor generate a bias voltage according to a drain current corresponding to the control voltage,
wherein the fourth transistor transmits the generated bias voltage to the error amplifier.

12. The apparatus of claim 9, wherein the voltage droop predictor comprises,
a fifth transistor connected to an input voltage; and
a droop detector whose output node is connected to a point where an output voltage generated from the pass transistor is transmitted to a load, and that, when at least one of a voltage droop signal in which the output voltage droops below a certain range and the wake-up signal is detected, turns on the fifth transistor so that the input voltage is transmitted to the load connected to the output node.
